(19) United States
(12) Patent Application Publication
(10) Pub. No.: US 2024/0370469 A1
(43) Pub. Date: Nov. 7, 2024

(54) Navigation-Integrated Service Booking

(71) Applicant: Google LLC, Mountain View, CA (US)

(72) Inventors: Yan Mayster, Aurora, CO (US); Robert Bruce Bahnsen, Boulder, CO (US)

(21) Appl. No.: 18/247,764

(22) PCT Filed: Aug. 1, 2022
(86) PCT No.: PCT/US2022/039081

§ 371 Date: Apr. 4, 2023

(51) Int. Cl. G06F 16/29; G06F 16/248

(52) U.S. Cl. CPC G06F 16/29; G06F 16/248

(57) ABSTRACT

The present disclosure provides computer-implemented methods, systems, and devices for providing booking within a navigation application. A computing device receives a query, the query requesting the location of one or more entities. The computing device determines, using a database of geographic location data, one or more entities associated with the query. The computing device generates query response data indicative of one or more data elements within the database of geographic location data, wherein a respective data element within the one or more data elements includes a location of a respective entity in the one or more entities, a time, and a value. The computing device transmits the query response data to a user computing device for display within the user interface of a navigation application.

The present disclosure relates generally to route navigation. More particularly, the present disclosure relates to integrating automatically using constraints to generate optimal routes for pickups and deliveries.

### BACKGROUND

As computer technology has improved, the number and type of services that can be provided to users have increased dramatically. The services provided via computer technology include navigation services. A navigation service can allow a user to navigate from a current location to a destination location. The user can submit a query through an application associated with a navigation service. The navigation service can, in response to the query, provide information about possible destination locations. If a user selects a destination, the navigation service can, using map data for a geographic area, generate a planned route to the destination. In some examples, the planned route includes one or more turn-by-turn navigation directions.

### SUMMARY

Aspects and advantages of embodiments of the present disclosure will be set forth in part in the following description, or can be learned from the description, or can be learned through practice of the embodiments.

An example aspect is directed towards a computer-implemented method. The method comprises receiving, by a computing system including one or more processors, a query, the query requesting the location of one or more entities. The method further comprises determining, by the computing system using a database of geographic location data, one or more entities associated with the query. The method further comprises generating, by the computing system, query response data indicative of one or more data elements within the database of geographic location data, wherein a respective data element within the one or more data elements includes a location of a respective entity in the one or more entities, a time, and a value. The method further comprises transmitting, by the computing system, the query response data to a user computing device for display within the user interface of a navigation application.

Other aspects of the present disclosure are directed to various systems, apparatuses, non-transitory computer-readable media, user interfaces, and electric devices.

These and other features, aspects, and advantages of various embodiments of the present disclosure will become better understood with reference to the following description and appended claims. The accompanying drawings, which are incorporated in and constitute a part of this specification, illustrate example embodiments of the present disclosure and, together with the description, serve to explain the related principles.

### BRIEF DESCRIPTION OF THE DRAWINGS

Detailed discussion of embodiments directed to one of ordinary skill in the art is set forth in the specification, which makes reference to the appended figures, in which:

FIG. 1 depicts an example computing system according to example embodiments of the present disclosure;

FIG. 2 depicts an example client-server environment according to example embodiments of the present disclosure:

FIG. 3 illustrates an example scheduling system in accordance with example embodiments of the present disclosure:

FIG. 4 depicts an example user interface according to example embodiments of the present disclosure:

FIG. 5 illustrates an example flow diagram representing the steps for improving a navigation application by incorporating the ability for users to schedule services with a guaranteed time and a guaranteed price from within the navigation application in accordance with example embodiments of the present disclosure; and

FIG. 6 depicts an example flow diagram for a method for improving a navigation application by incorporating the ability for users to schedule services with a guaranteed time and a guaranteed price from within the navigation application in accordance with example embodiments of the present disclosure.

### DETAILED DESCRIPTION

Reference now will be made in detail to embodiments of the present disclosure, one or more examples of which are illustrated in the drawings. Each example is provided by way of explanation of the present disclosure, not limitation of the present disclosure. In fact, it will be apparent to those skilled in the art that various modifications and variations can be made to the present disclosure without departing from the scope or spirit of the disclosure. For instance, features illustrated or described as part of one embodiment can be used with another embodiment to yield a still further embodiment. Thus, it is intended that the present disclosure covers such modifications and variations as come within the scope of the appended claims and their equivalents.

Generally, the present disclosure is directed to a system for improving a navigation application by incorporating the ability for users to schedule services with a guaranteed time and/or a guaranteed value from within the navigation application. To do so, a navigation service can include a scheduling system. The navigation system can receive navigation queries from the users (via applications on user computing devices). In some examples, the navigation queries can include text that is associated with the performance of a service. In response, the scheduling service can identify one or more entities (e.g., merchants, businesses, or potential service providers) that provide the service indicated by the navigation query. The scheduling system can access up-to-date availability information for the one or more identified entities. The up-to-date availability information can be stored in a database of geographic location data that is kept up to date with scheduling information from the one or more entities.

The scheduling system can identify one or more time slots during which the service can be performed and at least one service provider that is able to provide the service. For each time slot, the scheduling system can determine a value associated with the service at that time slot. The value can be a fixed or guaranteed value. A fixed or guaranteed value can be guaranteed to remain the same once the user has accepted a particular timeslot with a corresponding fixed value.

The service scheduling system can generate query response data by selecting one or more candidate entities (with an associated value and a time). The query response data can be transmitted to the user computing device for display in a navigation application. The user can select a particular entity with an associated time and at a particular value. The selected entity can transmit the selected offer to the navigation service. The navigation service can notify the entity (e.g., service provider) of the scheduled service, update the database to include the scheduled service, and keep the database of geographic location data up to date with availability information.

For example, if a user submits “haircut” as a search query to the navigation system, the scheduling system associated with the navigation system can access the database of geographic location data to identify one or more entities (e.g., businesses, merchants, individuals, or service providers) that provide haircuts. Based on the location of the user, the location of the one or more entities, and any time preference information provided by the user, the scheduling system can identify open time slots at one or more haircut providers. The haircut providers can be filtered to remove any providers that are too distant or do not have open time slots during a time window indicated by the user in the navigation query. For the remaining time slots, the scheduling system can determine a specific price guarantee (e.g., a fixed value) for each time slot. The list of times and values can be transmitted to the user for display in the user interface of a navigation application on the user computing device. The user can select one of the times and values and transmit information describing the selected entity and the time and value back to the navigation system. The navigation system can then inform the entity of the time and the value at which the service was booked. The database of geographic location data can be updated to indicate that the selected time slot is no longer available. In some examples, the navigation application can provide turn-by-turn navigation directions to the selected entity. In some examples, the navigation directions can include a suggested start time, so the user is able to arrive at the scheduled time for their scheduled service.

More specifically, a computing device can include a server computing system. A server computing system can be any computing system configured to communicate with a user computing device (or other computing devices) over a network to provide a service. A user computing device can be any computing device that is designed to be operated by an end-user. For example, a user computing device can include, but is not limited to, a personal computer, a smartphone, a smartwatch, a fitness band, a tablet computer, a laptop computer, a navigation computing device, a wearable computing device, and so on. In some examples, a user computing device can include one or more sensors intended to gather information, with the permission of the user, such as location information for the user computing device.

A navigation application can be any application configured to provide navigation information to a user upon request. For example, a navigation application can provide turn-by-turn directions from a starting location to an ending location. A navigation application can also allow a user to search based on keywords for locations in a particular geographic area. For example, a user can submit a query (e.g., using keywords or search terms) to the navigation application along with a specific geographic location. In response to the received query, the navigation application can generate geographic information associated with the query.

The server computing system that provides services for a navigation application can receive a navigation request from a user computing device. In some examples, the navigation request can include a destination. In some examples, the navigation request can also include an origination point. The origination point can be the current location of the user computing device (e.g., as determined by a global positioning system or other location determining system).

In some examples, the query can include search terms. In some examples, the search terms can be associated with particular locations. For example, the search terms can be “water fountain.” The server computing system can identify locations associated with the search terms. In some examples, the search terms can be associated with one or more services. When the server computing system associated with the navigation service determines that the search terms are associated with a service, the server computing system can employ a scheduling system. The scheduling system can access a database of geographic location data.

The database of geographic location data can store data from a plurality of different entities (e.g., any type of service provider). For each entity, the database of geographic location data can include information about the entity's location, the types of services provided, and a live representation of its current schedule or calendar. The live representation of current schedules or calendars can include any reserved services that are scheduled in the future as well as current availability. In some examples, entities can submit availability information to the database of geographic location data via a computing network as new services are scheduled or reserved. In addition, for each service and time, the database of geographic location data can include a value associated with the services that are to be performed (e.g., a price). In some examples, the value can vary by time, location, and one or more other factors. For example, during times of high busyness, the guaranteed value associated with a service may rise.

Using this information, the scheduling system can determine the availability of each entity for a plurality of potential time slots. The scheduling system can determine the target time window for a particular service. In some examples, the target time window can be based on the estimated arrival time of a user. For example, a user that is already navigating to a potential destination using the navigation application will have an associated time of arrival at the selected destination. If the service is associated with the destination, the scheduling system can determine the availability of services around the estimated time of arrival.

In other examples, the target time window can be based, at least partially, on a travel time to the location. The scheduling system can determine the earliest open time slot available for a plurality of different entities and filter the open time slots based on the travel time to that entity. Thus, the specific target time window may differ depending on the location of the entity. The scheduling system can calculate the time of travel from the user's current location to each of the candidate entities and identify the earliest open time slot at one or more entities available to the user based on the estimated travel time. For example, if the travel time is estimated at 30 minutes, the scheduling system can filter out or disregard any open time slots that start before that trip could be completed.

In other examples, the target time can be based on information included in the query. For example, a user can include a target start time for the service, a time window in which the user is available, or a target end time for the service. The scheduling system can then identify one or more service providers that have availability in one or more time slots within the target time window.

For example, if a user wishes to have an oil change at 4:00 PM, the scheduling system can identify any service provider within the geographic area with an opening at 4:00 PM. If no entity is available at that time, the scheduling system may select the closest available open time slot to 4:00 PM. Once one or more available slots are identified, the scheduling system can determine the price associated with each available time slot. For example, different entities may charge different rates and each entity may have different rates at different times of the day.

In some examples, the user may indicate that the time is not flexible and if the system can determine that no open time slots are available within the user's travel range. The scheduling system can notify the user that it was not able to identify an open time slot at the requested time.

The scheduling system can identify a plurality of candidate entities that have availability during one or more times during which the user wishes the service to be performed. In some examples, the scheduling system can rank the entities based on one or more factors. For example, the amount of travel time to the entity location can be used to rank the candidate entities. In some examples, the guaranteed value can be used to rank the candidate entities. Additionally, or alternatively, the entities can be ranked based on the earliest start time (including travel time).

In some examples, the scheduling system can determine a ranking for a particular entity by determining a trade-off rate between time and value. For example, a particular value can be associated with each minute of travel time and that value can be added to the estimated total value for a service. In some examples, the trade-off rate can be determined for each user based on the mode of travel for the user. For example, the rate of tradeoff per minute may be greater for a user traveling by cost than for a user traveling by foot. In addition, if the user supplies information about the specific vehicle they are using, the cost per minute can also be customized to reflect the cost of operating a particular vehicle. In this way, the cost per minute for an electronic vehicle can be less than the cost per minute of a combustion engine-based vehicle. Alternatively, the scheduling system can rank the entities without reference to the cost of travel time.

The service provider database can store reputation data for the entities. In some examples, the reputation data can be based on reviews and feedback from users. Users can rate one or more entities based on whether the selected entity performed the scheduled service at the guaranteed time and the guaranteed price. Entities that fail to provide the service as guaranteed can have their reputations negatively affected and rank lower in future recommendations.

Similarly, reputation data for users can be stored in their profiles. In some examples, the navigation application may only present the option to book a service if the user's reputation exceeds a threshold. Thus, if a user routinely misses scheduled times for services, the navigation system may stop offering to schedule such services for the user. In some examples, the price may be adjusted based on the reputation of the user.

In some examples, a user can employ the navigation application to generate directions to the selected entity to receive the booked service. The navigation application can track the position of the user computing device as the user travels towards the location of the entity. Once the user arrives at the location, the navigation application can provide a check-in service to notify the entity that the user has arrived. In some examples, the check-in service can use a GPS location determination device (or another location determine device) to verify or confirm the user's location for check-in. In some examples, a payment transaction can be initiated when the user arrives at the location of the entity.

In some examples, the location information and travel tracking provided by the navigation application can be used to generate reputation information for the user and/or the entity. For example, if the user is predicted to arrive later than the scheduled time to the service, the entity can be notified, and the user's reputation data can be updated. Similarly, if a user arrives and checks in on time, but the entity does not commence the service at the scheduled time, the reputation data of the entity can be updated. This process can be performed automatically using location and check-in data gathered by the navigation application. In this way, reputation data for a plurality of users and entities can be generated and kept up to date automatically and in real-time.

Once the navigation system ranks one or more entities (and the available time slots associated with the one or more service providers), the scheduling system can select one or more time slots to be included in the query response data for recommendation to the user. In some examples, the total number of time slots included in the query response data can be determined based, at least in part, on the amount of space available in the user interface in which the navigation application is displayed or the size of the display associated with the user computing device.

The query response data can be transmitted to the user computing device for display. The query response data can include one or more service times and prices, both of which can be guaranteed to be valid for the user. Each time slot can be associated with a different entity. The user interface of the navigation application can be customized to allow the user to sort the offers based on one or more factors including distance to provider, time until service, price, and so on.

The user can select one or more of the offers. In response to the user selecting an offer, the user computing device can transmit the selected offer data to the navigation system. The scheduling system can update the stored service provider data to include the scheduled service.

In some examples, the navigation system can also generate navigation instructions from the user's location to the selected service provider. In some examples, the navigation system can also generate an estimated leave time for the user to ensure that the user is able to reach the selected service provider at the appropriate time.

The scheduling system can determine whether a particular activity is available based on a maximum attendance level or a ticketing system. For example, if the user searching for a particular play, the scheduling system can determine, based on ticketing data provided by the theater, whether the play still has tickets available. If so, the scheduling system can generate an option for the user to purchase tickets for a particular showing and generate navigation directions to the location of the theater. Similarly, for an entity with a maximum attendance level such as an amusement park, the scheduling system can determine whether the amusement park has exceeded the attendance level. The scheduling system can notify the user whether the amusement park has exceeded the attendance level.

In some examples, if a user is traveling to a location, the scheduling system can determine whether nearby parking lots have parking availability. If so, the scheduling system can enable the user to reserve or pay for parking and generate directions to the parking lot with availability.

The navigation system can receive payment information from the user computing device. Using the payment information (e.g., account data provided by the user), the navigation system can initiate a transaction with an entity to pay for the selected service. If the service is associated with a ticket (e.g., access to a museum, a concert, a sporting event, and so on), the navigation system can provide the ticket information to the user through the navigation interface.

The systems and methods of the present disclosure provide a number of technical effects and benefits. As one example, the proposed systems can provide the ability to book services within a navigation application at a guaranteed time and at a guaranteed price. Automatically providing service booking within a navigation application can enable the navigational application to provide more efficient navigation services to a user. Improving the effectiveness of navigation applications can reduce the amount of storage needed and energy used when providing navigation information. Further, a more efficient navigation service can provide faster and/or more fuel-efficient routes for the user. Reducing the amount of storage needed and energy used reduces the cost of the navigation service associated with the navigation application and improves the user experience. This represents an improvement in the functioning of the device itself.

With reference now to the Figures, example embodiments of the present disclosure will be discussed in further detail.

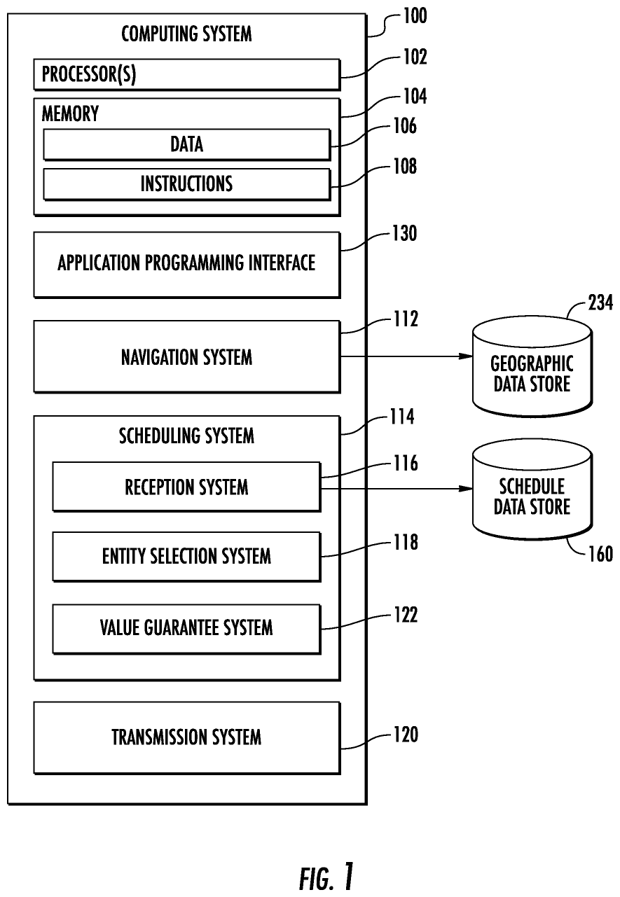

FIG. 1 depicts an example computing system 100 according to example embodiments of the present disclosure. In some example embodiments, the computing system 100 can be any suitable device, including, but not limited to, a smartphone, a tablet, a laptop, a desktop computer, a server computing system, or any other computing device that is configured such that it can allow a person to execute a navigation service The computing system 100 can include one or more processor(s) 102, memory 104, an application programmatic interface 130, a navigation system 112, a scheduling system 114, and a transmission system 120.

The one or more processor(s) 102 can be any suitable processing device, such as a microprocessor, microcontroller, integrated circuit, or other suitable processing device. The memory 104 can include any suitable computing system or media, including, but not limited to, non-transitory computer-readable media, RAM, ROM, hard drives, flash drives, or other memory devices. The memory 104 can store data 106 accessible by the one or more processor(s) 102, including instructions 108 that can be executed by the one or more processor(s) 102. The instructions can be any set of instructions that when executed by the one or more processor(s) 102, cause the one or more processor(s) 102 to provide the desired functionality.

In particular, in some devices, memory 104 can store instructions for implementing the application programmatic interface 130, the navigation system 112, the scheduling system 114, and a transmission system 120. Thus, the computing system 100 can implement the application programmatic interface 130, the navigation system 112, and the transmission system 120 to execute aspects of the present disclosure, including receiving a navigation query from a user, identifying one or more entities that can satisfy the query, determining a list of available time slots and prices at the identified one or more entities, and transmitting the list of time slots and prices to the user computing device for display inside a navigation application.

It will be appreciated that the terms “system” or “engine” can refer to specialized hardware, computer logic that executes on a more general processor, or some combination thereof. Thus, a system or engine can be implemented in hardware, application specific circuits, firmware, and/or software controlling a general-purpose processor. In one embodiment, the systems can be implemented as program code files stored on a storage device, loaded into memory and executed by a processor or can be provided from computer program products, for example computer executable instructions, that are stored in a tangible computer-readable storage medium such as RAM, hard disk, or optical or magnetic media.

Memory 104 can also include data 106, such as geographic data associated with the navigation system 112 (e.g., data representing a geographic area including one or more roads, one or more locations of interest, and one or more entities) or schedule data used by the scheduling system 114 to identify open time slots and prices (e.g., values) that can be retrieved, manipulated, created, or stored by the one or more processor(s) 102. In some example embodiments, such data can be accessed, displayed, or transmitted as needed.

In some example embodiments, the computing system 100 includes an application programmatic interface 130, a navigation system 112, a scheduling system 114, and a transmission system 120. The application programmatic interface 130 can be a software interface that allows users or computer programs to interact with the service over a network. The API 130 has an associated specification that describes the standard way to interact with the API 130 to achieve a desired result offered by the service for which the API 130 is associated. In this example, the API serves to act as an interface between one or more user computing devices and the computing system 100 as well as an interface between one or more entities (e.g., business, merchants, or other service providers) and the computing system 100.

One or more entities can, using a computing system that communicates to the API 130 over a computing network, access and interact with this API 130 to provide information about time availability and prices associated with each time. In some examples, the APIs 130 can store any received scheduling data in the schedule data store 160. The API 130 can enable the schedule data store 160 to store and up-to-date or live representation of the schedule of service at each of the plurality of entities. In some examples, an entity's own scheduling computing system can automatically provide the information to the computing system 100 when the calendar is updated at the entity.

This information can be used by the scheduling system 114 to determine when each entity has available time. The schedule data store 160 can also store price information for each entity. In this way, the entities can indicate the price of one or more service time slots and can update those prices in real-time in response to updated schedule information. For example, the price can be determined in response to a plurality of factors, including the amount of time until the respective time slot, busyness associated with the entity, the reputation of the user, and so on. Some entities can provide discounts for users who book services a certain amount of time in advance or to users with high reputations. As the busyness of a particular entity increases, the price associated with an open time slot may also increase.

The computing system 100 can include a navigation system 112. The navigation system 112 can provide route information for users to enable a user to travel from an initial location to an ending location (e.g., a destination). In some examples, the navigation system 112 can receive a destination address from a user. In response, the navigation system 112 can access a geographic data store. Using the information in the geographic data store, the navigation system 112 can determine one or more possible routes from the initial location to the destination.

The navigation system 112 can provide, in a display, a visual depiction of a geographic area. The visual depiction of the geographic area can include one or more streets, one or more points of interest (including buildings, landmarks, and so on), and a highlighted depiction of a planned route. In some examples, the navigation system 112 can also provide location-based search options to identify one or more searchable points of interest within a given geographic area.

In some examples, the navigation system 112 can receive a search query from a user. The search query can include one or more words. In some examples, the search query can be associated with navigation intention. For example, a search query can include a word that refers to one or more navigation locations. Thus, a search query can be a navigational query. For example, the query can be “haircut.” The term “haircut” does not necessarily have, on its own, any specific relation to navigation. However, the navigation service 130 can determine that a user submits the navigation query “haircut” in the attempt to identify one or more locations that can provide a haircut to the user.

In some examples, if the navigation system determines that the navigation query is associated with one or more types of services, the navigation system 112 can access the scheduling system 114 to identify one or more entities that can provide the indicated service.

In some examples, the scheduling system 114 includes a reception system 116, add provider selection system 118, and a value guarantee system 122. In some examples, the reception system 116 can receive one or more navigational queries. The navigational queries can be received from the navigation system on 12 and can include terms associated with one or more locations or a service. The scheduling system 114 can determine, based on the query, one or more services that the user intends to access or a ticketed event the user wishes to attend. For example, the service can be something like an oil change or a haircut or the ticketed service can be a sporting event, an amusement park, a theater, or so on.

In some examples, the scheduling system 114 can identify a type of entity with which the navigation queries are associated, or a specific location associated with the navigation query. Based on the determined type, the scheduling system can access the schedule data store 160 based on information received from the geographic data store 234. For example, the scheduling system 114 can determine a list of candidate entities associated with a type of service indicated by the query. For a specific example, the query could include the terms “oil change” and the list of candidate entities can include any entity within a predetermined distance from the user that provides an oil change service.

The entity selection system 118 can, using a list of candidate entities, access the scheduled data store 160. In some examples, for each candidate entity in the list of candidate entities, the entity selection system 118 can determine whether or not that entity has any open time slots during which the entity is available to provide a particular service. The schedule data store 160 can include schedule information for one or more of the candidate entities. In some examples, entities can proactively provide scheduling information to the scheduled data store 160 to enable the scheduling system 114 to accurately determine when an entity has open or available time slots.

The entity selection system 118 can rank each candidate entity in the list of candidate entities based on one or more factors. The factors can include the distance from the location of the user (e.g., provided by the user), the wait until the available time slot occurs, one or more preferences received from the user, and reputation data associated with the one or more entities. Each candidate entity can be given a score based on one or more factors. The entity selection system 118 can then select one or more of the plurality of candidate entities based on their associated score. In some examples, only a single entity is selected. In another example, the entity selection system 118 can select more than one candidate entity for recommendation to the user.

In some examples, each selected entity has one or more open time slots. Each time slot can be associated with a guaranteed value by the value guarantee system 122. The value guarantee system 122 can determine a specific price at which the service provided by the one or more entities can be guaranteed to be performed. Thus, each time can be associated with a particular price or value (e.g., a guaranteed price or value). In this way, a potential time and value can be provided to the user in the user interface of a navigation application. The user can select a particular time with an associated price via the user interface of the navigation application.

Once the value guarantee system 122 has determined a specific price for each candidate available time slot, the transmission system 120 can transmit a query response saying that including the one or more available time slots and corresponding prices, to a user computing device. The available time slots and prices can be displayed to the user in the user interface associated with the navigation application. The user can, directly in the interface of the navigation application, select one of the suggested time slots. In response, the user computing device can transmit the user selection data to the computing system 100 and the system can book the user service at the selected time and price.

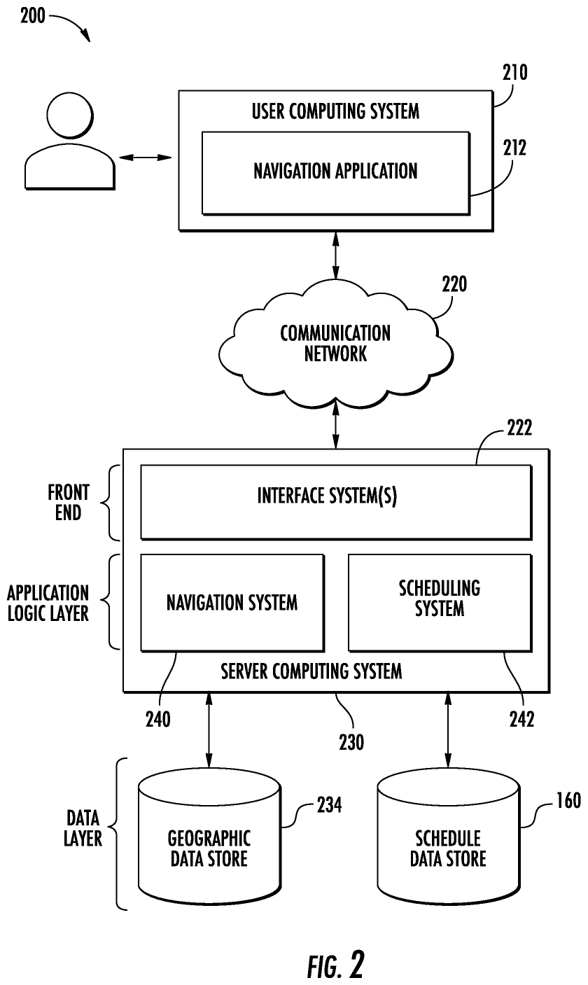

FIG. 2 depicts an example client-server environment 200 according to example embodiments of the present disclosure. The client-server system environment 200 includes one or more user computing systems 210 and a server computing system 230. One or more communication networks 220 can interconnect these components. The communication networks 220 may be any of a variety of network types, including local area networks (LANs), wide area networks (WANs), wireless networks, wired networks, the Internet, personal area networks (PANs), or a combination of such networks.

A user computing system 210 can include, but is not limited to, smartphones, smartwatches, fitness bands, navigation computing devices, laptop computers, desktop computing systems, and embedded computing devices (computing devices integrated into other objects such as clothing, vehicles, or other objects). In some examples, a user computing system 210 can include one or more sensors intended to gather information with the permission of the user associated with the user computing system 210.

In some examples, the user computing system 210 can connect to another computing device, such as a personal computer (PC), a laptop, a smartphone, a tablet, a mobile phone, an electrical component of a vehicle, or any other electric device capable of communication with the communication network 220. A user computing system 210 can include one or more application(s) such as search applications, communication applications, navigation applications 212, productivity applications, game applications, word processing applications, or any other applications. The application(s) can include a web browser. The user computing system 210 can use a web browser (or other application) to send and receive requests to and from the server computing system 230. The application(s) can include a navigation application 212 that enables the user to send navigation queries to the server computing system 230 and receive query response data in response.

In some examples, the user computing system 210 can include one or more sensors that can be used to determine, with the express permission of the user, information associated with the environment of the user computing system 210 or information associated with the user of the user computing system 210 (such as the position or movement of the user). In some examples, the sensors can include a motion sensor to detect the movement of the device or the associated user, a location sensor (e.g., a GPS) to determine the current location of the user computing system 210, and an audio sensor to gather audio information in the area of the user computing system 210.

As shown in FIG. 2, the server computing system 230 can generally be based on a three-tiered architecture, consisting of a front-end layer, application logic layer, and data layer. As is understood by skilled artisans in the relevant computer and Internet-related arts, each component shown in FIG. 2 can represent a set of executable software instructions and the corresponding hardware (e.g., memory and processor) for executing the instructions. To avoid unnecessary detail, various components and engines that are not germane to conveying an understanding of the various examples have been omitted from FIG. 2. However, a skilled artisan will readily recognize that various additional components and engines may be used with a server computing system 230, such as that illustrated in FIG. 2, to facilitate additional functionality that is not specifically described herein. Furthermore, the various components depicted in FIG. 2 may reside on a single server computer or may be distributed across several server computers in various arrangements. Moreover, although the server computing system 230 is depicted in FIG. 2 as having a three-tiered architecture, the various example embodiments are by no means limited to this architecture.

As shown in FIG. 2, the front end can consist of an interface system(s) 222, which receives communications from one or more user computing systems 210 and communicates appropriate responses to the user computing systems 210. For example, the interface system(s) 222 may receive requests in the form of Hypertext Transfer Protocol (HTTP) requests, or other web-based, application programming interface (API) requests. The user computing system 210 may be executing conventional web browser applications or applications that have been developed for a specific platform to include any of a wide variety of computing devices and operating systems.

As shown in FIG. 2, the data layer can include a geographic data store 234. The geographic data store 234 can store a variety of navigation data. For example, the geographic data store 234 can include map data. In some examples, the map data can include information describing locations, points of interest, buildings, roads, parks, and other geographic features. The map data can include information correlating addresses with specific geographic locations such that a user can input an address and information about that address (e.g., what buildings, if any, are at that location) can be provided. Similarly, a user can enter the name of a location or point of interest and the system can identify the address associated with that location. In some examples, the user can submit a query that is associated with a type of service. In response, the navigation system 240 can identify one or more entities in the geographic data store 234 that are associated with providing the service.

In some examples, the geographic data store 234 can include information that is associated with location determining systems such as the global positioning system (GPS) such that the location of a specific computing device can be determined with respect to the map data. The geographic data store 234 can include direction data that can allow the navigation system 240 to generate routes from an initial location to a particular destination location. In some examples, the geographic data store 234 can include location characteristic information about a plurality of locations or entities. As noted above, the location characteristic information can include the address of the location, the geographic position of the location, the type of the location, the type of entity, the hours of operation of the entity, the goods and services available from the entity (if any), and so on.

In some examples, the geographic data store 234 can also include image data, the image data associated with one or more geographic areas. The geographic data store 234 can also include satellite image data associated with one or more geographic areas.

The schedule data store 160 can store data associated with the schedule of one or more entities represented in the geographic data store 234. For example, the schedule data store can store a schedule or calendar for each entity in the geographic data store 234 representing the number of time slots in each day and the availability of each time slot. For example, if an entity is a hair salon, and each appointment lasts one hour, the scheduled data store 160 can determine, for each hour time slot that the hair salon is open, whether an appointment is booked for that time slot.

The schedule data store 160 can also include information describing a price or value associated with each time slot. Thus, the scheduling system 242 can access the schedule data store 160 to determine, for a list of potential candidate entities, what time slots are currently available and a price or value associated with the available time slots.

The application logic layer can include a navigation system 240 and a scheduling system 242. A navigation system 240 can provide, for display, data enabling a visual depiction of a geographic area. The visual depiction of the geographic area can be a map visualization including one or more streets, one or more points of interest (including buildings, landmarks, and so on), and a highlighted depiction of a planned route. The navigation system 240 can receive, via the interface, a navigation query. In some examples, the query can include an initial location and a target destination. The navigation system 240 can generate a plurality of candidate routes from the initial location to the target destination.

The navigation query can include one or more search terms. The search terms can describe one or more features or attributes of entities in the geographic data store 234. The navigation system 240 can access the geographic data store 234 to identify a list of candidate entities that match the features or attributes indicated by the one or more search terms. In some examples, the one or more search terms can be associated with services that can be provided by the one or more entities. For example, the search term “haircut” can be associated with entities that provide haircut services. The navigation system 240 can generate a list of candidate entities that are associated with providing haircut services and are within a predetermined distance of the user computing system 210.

The navigation system 240 can pass the list of candidate entities to the scheduling system 242. The scheduling system 242 can determine, for each candidate entity in the list of candidate entities, whether up-to-date scheduling information for the candidate entity is available in the schedule data store 160. In some examples, only entities that provide their scheduling information to the scheduling data store regularly can be considered by the schedule system 242.

Once the scheduling system 242 has determined that a respective entity has associated and up-to-date scheduling information stored in the schedule data store 160, the scheduling system 242 can determine one or more available time slots. In some examples, the available time slots can be determined in consideration of a time window submitted with the query. For example, a user can indicate a time window in which they would like to receive a service. In some examples, the time window can be based on a received target start time, a received target end time, or a target time window.

The scheduling system 242 can generate a list of available time slots for a plurality of entities. For each time slot, the scheduling system 242 can determine a value that a user would be expected to pay for the service in that particular time slot (e.g., a guaranteed price). The scheduling system 242 can rank each available time slot based on a plurality of factors. The factors can include, but are not limited to, the distance to the associated entity, how well the time slot matches the target time window provided by the user, the price, the reputation of the one or more entities, the estimated wait time, and so on. In some examples, the price of the service can be combined with the estimated cost of travel time to generate an actual price for the user. Thus, available time slots that have significant travel time may be ranked lower than closer time slots that have less travel time even if the closer time slot has a higher price.

In some examples, the query can be received as a user is on a trip to a particular destination. For example, a user can be traveling to a theme park and, during the trip, can search for one or more services associated with the theme park (e.g., parking). The target time window can be based on the estimated time of arrival of the user to the destination. In some examples, a user can be using the navigational application to travel to a particular location and the navigational application can determine that a particular service may be helpful to the user without a specific user submitted navigation query. For example, if the user is traveling to a dense urban area, the navigational application may determine that the user may require assistance in identifying a parking location. The navigation application can use the scheduling system 242 to identify one or more parking entities in the area and determine their availability at the time of the user's arrival. The scheduling system 242 can recommend a parking entity with availability to the user.

Once the scheduling system has determined a ranked list of potential time slots, the scheduling system 242 can select one or more of the time slots based on their rankings to include in the query response data. The query response can then be transmitted to the user computing system 210. The user computing system 210 can present one or more available time slots in the user interface of the navigational application. The user can select one or more time slots. In response to the user selection, the user computing system 210 can transmit acceptance data to the server computing system 230. The server computing system 230 can then schedule the user as occupying that time slot, update the schedule data store 160, and notify the entity that the user has scheduled a service.

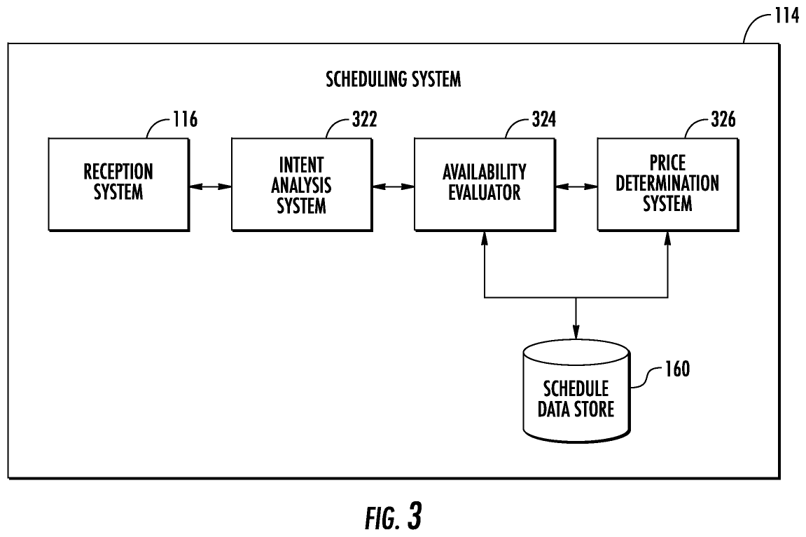

FIG. 3 illustrates an example scheduling system 114 in accordance with example embodiments of the present disclosure. The scheduling system 114 can include a reception system 116, an intent analysis system 322, an availability evaluator 324, and a price determination system 326.

For example, the reception system 116 can receive a navigation request. In some examples, the navigation request can indicate a particular destination. In other examples, a navigation request can include a query. The query can include one or more search terms that can be matched to one or more entities in the geographic data store 234. In some examples, the query can be a navigational query. The one or more search terms can be transmitted to the intent analysis system 322.

The intent analysis system 322 can analyze the received search terms, to determine whether the received search terms are associated with one or more services that can be provided by entities. In some examples, services can be distinguished from products that do not need to be scheduled. If the intent analysis system 322 determines that the received search terms are associated with accessing the service, as opposed to a destination or a product, the intent analysis system 322 can transmit the search terms to the availability evaluator 324.

The availability evaluator 324 can determine a list of candidate entities, and for each respective entity, determine whether or not the respective entity has any available time slots within a window of time designated by the user. For example, if the user indicates they would like to receive the service between 2:00 pm and 5:00 pm, the availability evaluator 324 can search the schedule data store 160 to identify any available time slots for entities within a distance threshold that are between 2:00 PM and 5:00 PM.

The availability evaluator 324 can transmit a list of available time slots to the price determination system 326. The price determination system 326 can determine, for each available time slot, a value amount (the value amount can be fixed or guaranteed to ensure that the user can receive the price which they select). The value amount can be a price at which the entity has agreed to perform the requested service. The value amount can vary based on the particular entities and the busyness associated with the time slot.

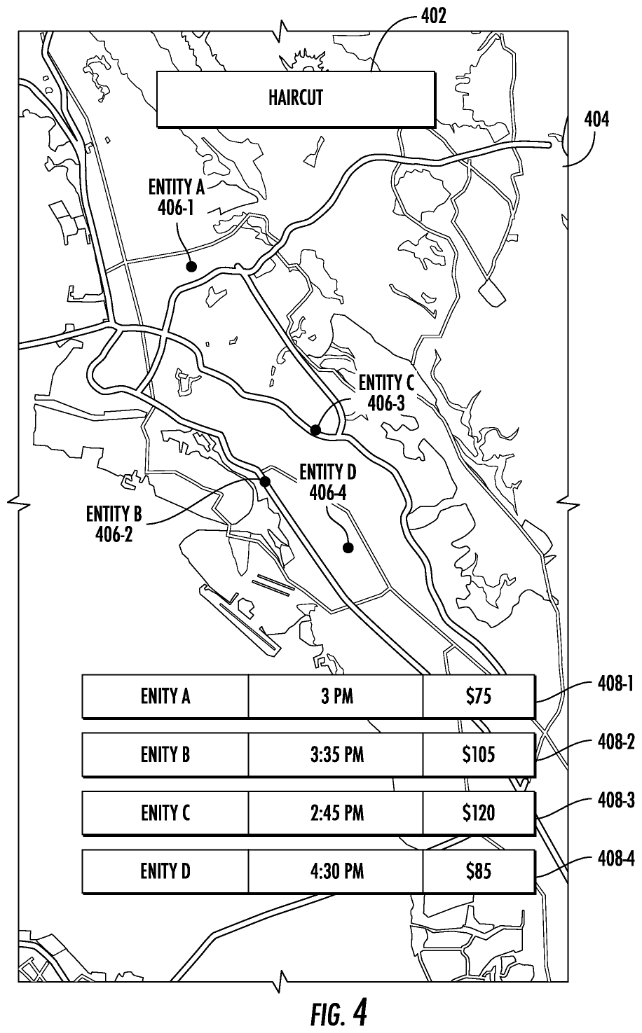

FIG. 4 depicts an example user interface according to example embodiments of the present disclosure. In this example, the user interface can display a geographic map 404 of an area nearby the user computing device. The interface can include search query field 402. The user can enter one or more search terms in the search query field 402. In this example, the search term is “haircut.”

In response, the navigation application can display the location of one or more entities in the interface overlaid on the location associated with each entity. The entities can include Entity A 406-1, Entity B 406-2, Entity C 406-3, and Entity D 406-4. In this example, these entities can be hair salons or barbers.

In some examples, the user interface can be updated to include a plurality of available time slots. Each time slot includes the name of the entity, a time associated with the time slot, and a price associated with the time slot. For example, four potential time slots are displayed. Timeslot 1 408-1 is associated with entity A at 3 pm and has a guaranteed price of $75. Timeslot 2 408-2 is associated with entity B at 3:35 pm and has a guaranteed price of $105. Timeslot 3 408-3 is associated with entity C at 2:45 pm and has a guaranteed price of $120. Timeslot 4 408-4 is associated with entity D at 4:30 pm and has a guaranteed price of $85. A user can select one of the displayed time slots to schedule the service to be performed at the associated entity for the price and at the time.

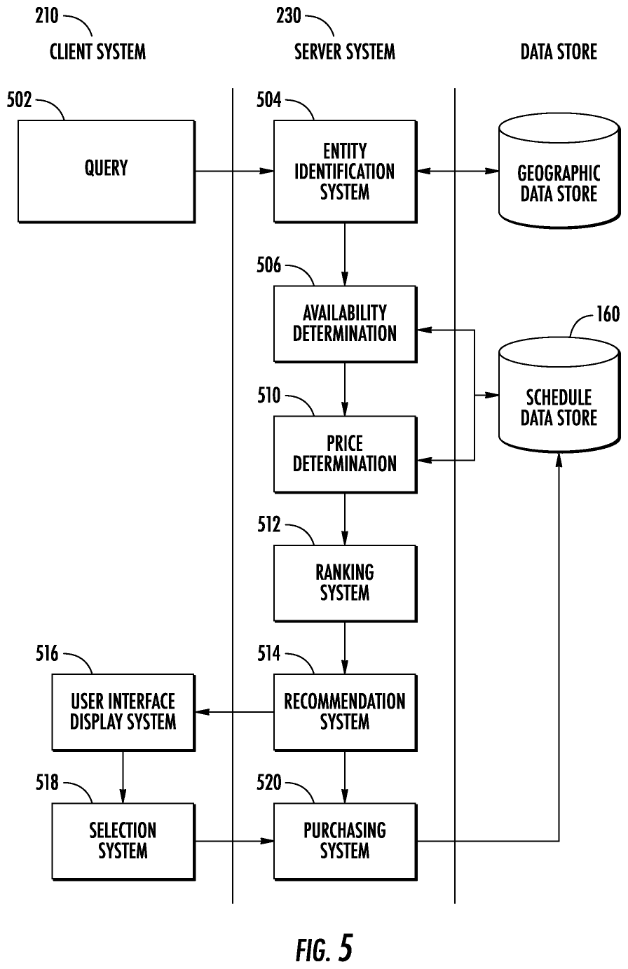

FIG. 5 illustrates an example flow diagram representing the steps for improving a navigation application by incorporating the ability for users to schedule services with a guaranteed time and a guaranteed price from within the navigation application in accordance with example embodiments of the present disclosure. In this example, a client system can transmit a query 502 to the server computing system 230. While transmitting the query 502, the client system can also transmit information associated with a requested time window and a location of the user. The query can include one or more search terms.

In some examples, the entity identification system 504 can receive the search terms from the search query. The entity identification system 504 can access the geographic data store 234. Based on the information retrieved from the geographic data store 234 (e.g., information about a plurality of entities within the geographic area of the client system) and the entity identification system 504 can identify a list of candidate entities that are associated with the one or more search terms. In some examples, the entity identification system 504 can exclude any entity that is too far from the location of the client system from the list of candidate entities.

The list of candidate entities can be transmitted to the availability determination system 506. The availability determination system 506 can, for each entity in the list of candidate entities, determine one or more time slots that are available for the candidate entity. In some examples, the availability determination system 506 can access the scheduled data store 160. The scheduled data store can store data describing the daily schedule of a plurality of entities. Based on the calendar or daily schedule, availability determination system 506 can identify one or more available time slots. In some examples, the available time slots are selected based on the time window received with the query 502 from the client system.

For each identified time slot, the price determination system 510 can identify a price (e.g., a guaranteed price). The price can be a price at which the entity has determined to deliver service to a user. The price information can be stored in the schedule data store 160. In some examples, different entities will have different prices for the same service. In some examples, a single entity can have different prices for the different time slots based on busyness, availability, the specific person to be performing the service, and any other factor.

A ranking system 512 can then rank each time slot based on the location of the entity, the amount of travel time for the user, the reputation of the entities, the price, the degree to which the time associated with the time slot matches the time window submitted by the user, and so on. The recommendation system 514 can then select one or more time slots for recommendation to the user. Each selected time slot can be included in query response data which is then transmitted to the user at the client system.

In some examples, a user interface display system 516 at the client system can present the one or more time slots to the user in the user interface associated with a navigation application. In this way, the user can select a particular time slot and book a service without ever leaving the navigation application. In doing so, the user is able to quickly and efficiently identify a particular location, a time, and a price for a service.

The selection system 518 can receive the user selection of the particular time slot. Information identifying the user selected time slot as well as user account information can be transmitted to the server system. The server system can include a purchasing system 530 that receives the selection and the account information. Using the account information, the purchasing system 530 can initiate a transaction to pay the selected entity for the booked service at the selected time slot. Information about the recent booking can be stored in the scheduled data store 160.

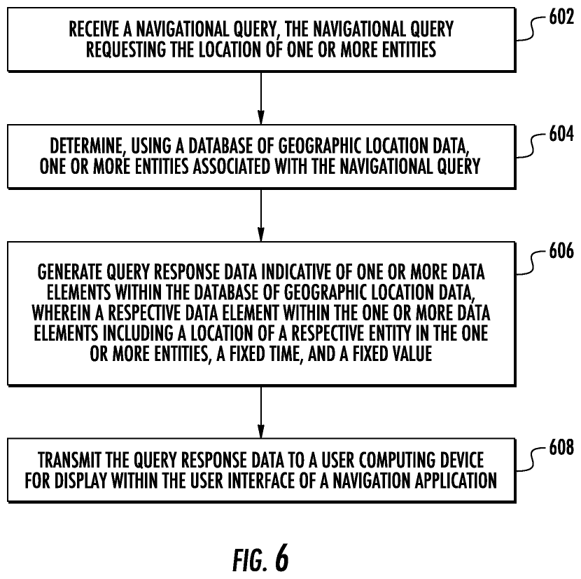

FIG. 6 depicts an example flow diagram for a method for improving a navigation application by incorporating the ability for users to schedule services with a guaranteed time and a guaranteed price from within the navigation application in accordance with example embodiments of the present disclosure. One or more portion(s) of the method can be implemented by one or more computing devices such as, for example, the computing devices described herein. Moreover, one or more portion(s) of the method can be implemented as an algorithm on the hardware components of the device(s) described herein. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, and/or modified in various ways without deviating from the scope of the present disclosure. The method can be implemented by one or more computing devices, such as one or more of the computing devices depicted in FIGS. 1-3.

A computing system (e.g., computing system 100 in FIG. 1) can include one or more processors, memory, and other components that, together, enable the computing system 100 to generate optimal routes for a list of tasks by automatically determining constraints that apply to each task. The computing system 100 can receive, at 602, the query requesting the location of one or more entities. The query can be received from a user currently traveling to a destination using navigation instructions provided by a navigation system. For example, a user can be on a trip following instructions provided by the navigation system.

The computing system can, at 604, determine, using a database of geographic location data, one or more entities associated with the query. The database of geographic location data can include information describing a plurality of entities (e.g., locations, businesses, landmarks, and so on), listing their locations, and metadata describing one or more characteristics of the entity (e.g., topics with which they are associated, products that the entity can provide, services that the entity provides, and so on).

The computing system can, at 606, generate query response data indicative of one or more data elements within the database of geographic location data, wherein a respective data element within the one or more data elements includes a location of a respective entity in the one or more entities, a time, and a value. The value can be a guaranteed price for which the entity (e.g., a merchant) will provide a service.

The computing system can determine a target time window for the navigation query. In some examples, the query includes one or more time indicators and the target time window is determined based on the one or more time indicators. The one or more time indicators can include one or more of a requested initiation time and a requested completion time.

In some examples, the computing system can determine a target time window by determining a route between the current location of the user and the one or more entities. The computing system determines the target time window based on an estimated time of arrival at one or more entities.

The computing system can determine one or more entities from the candidate entities with availability during the target time window. The computing system can determine, for the one or more candidate entities with availability during the target time window, a value during the target time window. For example, the value can be a determined price associated with the service. The price can be guaranteed to stay the same once it have been transmitted to the user.

In some examples, the computing system can determine a next available time slot for one or more entities in a plurality of the candidate entities based on the database of geographic location data. The computing system can obtain for the next available time slot for one or more entities, a value based on up-to-date data stored in the database of geographic location data. In some examples, the query response data includes candidate times and values for more than one entity. For example, the computing system can select a number of proposed times and values based on the specific interface in which the query response data is to be displayed (e.g., the more user interface space available, the more selected proposed times).

The computing system can receive a user-selected time and value for the respective entity. For example, the user can select a particular time and value based on the data transmitted to the user computing device as part of the query response data. In some examples, the computing system can transmit scheduling data to the respective entity. The computing system can update the database of geographic location data to represent the user-selected time and value for the respective entity.

In some examples, the database of geographic location data includes reputation data associated with one or more entities. The computing system can generate query response data indicative of one or more data elements within the database of geographic location data by determining a reputation score associated with one or more entities. The computing system can rank the one or more entities based, at least in part, on the reputation score associated with the one or more entities. The computing system can select one or more entities to include in the query response data based, at least in part, on the ranking associated with each entity.

The computing system can receive updated availability data associated with a respective entity in the one or more entities. In some examples, the computing system can store the updated availability data associated with the respective entity in a database of entity availability. In response to receiving a query associated with the respective entity, the computing system can query response data based, at least in part, on the updated availability data. In some examples, the computing system can, at 608, transmit the query response data to a user computing device for display within the user interface of a navigation application. In some examples, the computing system obtains account data associated with the user. The computing system can perform a transaction with the respective entity using the account data.

The technology discussed herein makes reference to sensors, servers, databases, software applications, and other computer-based systems, as well as actions taken, and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

1. A computer-implemented method, the method comprising:
receiving, by a computing system including one or more processors, a query, the query requesting the location of one or more entities;
determining, by the computing system using a database of geographic location data, one or more entities associated with the query;
generating, by the computing system, query response data indicative of one or more data elements within the database of geographic location data, wherein a respective data element within the one or more data elements includes a location of a respective entity in the one or more entities, a time, and a value; and
transmitting, by the computing system, the query response data to a user computing device for display within the user interface of a navigation application.

2. The computer-implemented method of claim 1, further comprising:
receiving, by the computing system, updated availability data associated with a respective entity in the one or more entities;
storing, by the computing system, the updated availability data associated with the respective entity in database of entity availability; and
in response to receiving a query associated with the respective entity, generating, by the computing system, query response data based, at least in part, on the updated availability data.

3. The computer-implemented method of claim 1, wherein generating, by the computing system, query response data indicative of one or more data elements within the database of geographic location data further comprises:
determining, by the computing system, a target time window.

4. The computer-implemented method of claim 3, wherein the query includes one or more time indicators and the target time window is determined based on the one or more time indicators.

5. The computer-implemented method of claim 4, wherein the one or more time indicators include one or more of a requested initiation time and a requested completion time.

6. The computer-implemented method of claim 3, wherein determining, by the computing system, a target time window further comprises:
determining, by the computing system, a route between a current location of the user and one or more entities; and
determining, by the computing system, the target time window based on an estimated time of arrival at one or more entities.

7. The computer-implemented method of claim 3 wherein generating, by the computing system, query response data indicative of one or more data elements within the database of geographic location data further comprises:
determining, by the computing system, one or more candidate entities from the one or more entities with availability during the target time window; and
determining, by the computing system and for the one or more candidate entities with availability during the target time window, a value during the target time window.

8. The computer-implemented method of claim 3, wherein generating, by the computing system, query response data indicative of one or more data elements within the database of geographic location data further comprises:
determining, by the computing system, a next available time slot for a respective candidate entity in the one or more entities based on the database of geographic location data; and
obtaining, by the computing system, a value for the next available time slot for the respective candidate entity, a value based on up-to-date data stored in the database of geographic location data.

9. The computer-implemented method of claim 1, wherein the query response data includes candidate times and values for more than one entity.

10. The computer-implemented method of claim 9, further comprising:
receiving, by the computing system, a user selected time and value for the respective entity; and
transmitting, by the computing system, scheduling data to the respective entity.

11. The computer-implemented method of claim 10, further comprising:
updating, by the computing system, the database of geographic location data to represent the user selected time and value for the respective entity.

12. The computer-implemented method of claim 1, further comprising:
obtaining, by the computing system, account data associated with the user; and
performing, by the computing system, a transaction with the respective entity using the account data.

13. The computer-implemented method of claim 1, wherein the query is received from a user currently traveling to a destination using navigation instructions provided by a navigation system and wherein the method further comprises:
determining, by the computing system, an estimated time of arrival for the user based on a user's location and a navigation route associated with the user; and
determining, by the computing system, an availability at an entity associated with the destination at the estimated time of arrival.

14. The computer-implemented method of claim 1, wherein the database of geographic location data includes reputation data associated with one or more entities and generating, by the computing system, query response data indicative of one or more data elements within the database of geographic location data further comprises:
determining, by the computing system, a reputation score associated with one or more entities;
ranking, by the computing system, the one or more entities based, at least in part, on the reputation score associated with the one or more entities; and
selecting, by the computing system, one or more entities to include in the query response data based, at least in part, on the ranking associated with each entity.

15. The computer-implemented method of claim 1, wherein the time is a fixed time and the value is a fixed value.

16. A computing device, the computing device comprising:
one or more processors; and
a computer-readable memory, wherein the computer-readable memory stores instructions that, when executed by the one or more processors, cause the computing device to perform operating comprising:
receiving a query, the query requesting the location of one or more entities;
determining, using a database of geographic location data, one or more entities associated with the query;
generating query response data indicative of one or more data elements within the database of geographic location data, wherein a respective data element within the one or more data elements includes a location of a respective entity in the one or more entities, a time, and a value; and
transmitting the query response data to a user computing device for display within the user interface of a navigation application.

17. A non-transitory computer-readable storage medium storing instructions that, when executed by one or more computing devices, cause the one or more computing devices to perform operating comprising:
receiving a query, the query requesting the location of one or more entities;
determining, using a database of geographic location data, one or more entities associated with the query;
generating query response data indicative of one or more data elements within the database of geographic location data, wherein a respective data element within the one or more data elements includes a location of a respective entity in the one or more entities, a time, and a value; and
transmitting the query response data to a user computing device for display within the user interface of a navigation application.

18. The non-transitory computer-readable storage medium of claim 17, further comprising:
receiving, by the computing system, updated availability data associated with a respective entity in the one or more entities;
storing, by the computing system, the updated availability data associated with the respective entity in database of entity availability; and
in response to receiving a query associated with the respective entity, generating, by the computing system, query response data based, at least in part, on the updated availability data.

19. The non-transitory computer-readable storage medium of claim 17, wherein generating, by the computing system, query response data indicative of one or more data elements within the database of geographic location data further comprises:
determining, by the computing system, a target time window.

20. The non-transitory computer-readable storage medium of claim 19, wherein the query includes one or more time indicators and the target time window is determined based on the one or more time indicators.
